(19) United States
(12) Patent Application Publication
(10) Pub. No.: US 2018/0375814 A1
(43) Pub. Date: Dec. 27, 2018

(54) TRACKING AND CONTROLLING MASS COMMUNICATIONS

(71) Applicant: Microsoft Technology Licensing, LLC, Redmond, WA (US)

(72) Inventor: Caitlin HART, Seattle, WA (US)

(21) Appl. No.: 15/633,975

(22) Filed: Jun. 27, 2017

(51) Int. Cl. H04L 12/58; G06F 3/0482; G06F 3/0484; H04L 29/08

(52) U.S. Cl. CPC H04L 51/22; H04L 67/306; G06F 3/04847; G06F 3/0482

(57) ABSTRACT

Systems and methods for tracking and controlling mass communications. One system includes an electronic processor configured to determine a plurality of mass communications received by a user via an electronic communications account, determine a plurality of unique senders of the plurality of mass communications, and determine, for each of the plurality of unique senders, at least one statistic. The electronic processor is also configured to generate and output a user interface including the at least one statistic of each of the plurality of unique senders, receive an input through the user interface, and, in response to the input, initiate at least one action associated with at least one of the plurality of unique senders.

### FIELD

Embodiments described herein relate to tracking and controlling electronic communications, such as email messages and, more particularly, to tracking and controlling mass communications, such as newsletters, marketing materials, and the like.

### SUMMARY

In addition to peer-to-peer correspondence, email messages are also used to distribute mass communications, including newsletters, marketing materials, and the like. As used in the present application, a mass communication is a bulk electronic communication sent from a sender to each of a plurality of individuals. The senders of such mass communications include individuals, organizations, companies, schools, brands, and the like. Mass communications may be sent in a solicited or unsolicited manner. For example, a user may sign-up or opt-in for mass communications. This type of solicited mass communication is sometimes referred to as “graymail,” and many users report that graymail accounts for over 80% of the user's electronic mailbox. Managing such a high number of communications is a daunting task for many users. Some users even resort to marking graymail as unsolicited communications (sometimes referred to as “spam”) to manage the extensive number of communications received by the user. Users, however, often have limited knowledge regarding how particular senders impact the user's mailbox, which makes it difficult for users to decide which communications are worthwhile and which are not or gives users an unsubstantiated perception that certain messages are received too frequently or take up too much space. Furthermore, even when a user decides that communications from a particular sender are not worthwhile and unsubscribes from the communications, the user must still address the previously-received communications from that particular sender. Accordingly, managing the hundreds or thousands of mass communications received from multiple different senders is a time-consuming and ever-growing obstacle for many users.

Thus, embodiments described herein provide, among other things, systems and methods for tracking and controlling mass communications. The systems and methods may identify mass communications sent to a user's email account and generate a user interface that presents the user with one or more statistics regarding the identified communications for each unique sender. In addition to informing the user of the impact of each unique sender on the user's mailbox, the user interface includes input mechanisms that allow a user to address the communications from one or more senders as a group. For example, the user interface may allow a user to delete all communications received from one or more senders, unsubscribe from communications received from one or more senders, or a combination thereof.

For example, one embodiment provides a system for tracking and controlling mass communications. The system includes an electronic processor configured to determine a plurality of mass communications received by a user via an electronic communications account, determine a plurality of unique senders of the plurality of mass communications, and determine, for each of the plurality of unique senders, at least one statistic. The electronic processor is also configured to generate and output a user interface including the at least one statistic of each of the plurality of unique senders, receive an input through the user interface, and, in response to the input, initiate at least one action associated with at least one of the plurality of unique senders.

Another embodiment provides a method for tracking and controlling mass communications. The method includes determining, with an electronic processor, a plurality of mass communications received by a user via an email account by identifying an unsubscribe link within a communication, determining, with the electronic processor, a plurality of unique senders of the plurality of mass communications, and determining, with the electronic processor, for each of the plurality of unique senders, at least one statistic. The method also includes generating and outputting, with the electronic processor, a user interface including the at least one statistic of each of the plurality of unique senders, receiving, with the electronic processor, an input through the user interface, and, in response to the input, initiating, with the electronic processor, at least one action for at least one of the plurality of unique senders.

Yet another embodiment provides a non-transitory computer-readable medium including instructions executable by an electronic processor to perform a set of functions. The set of functions includes determining a plurality of electronic communications having a predetermined property received by a user via an electronic communications account, determining a plurality of unique senders of the plurality of electronic communications, and determining, for each of the plurality of unique senders, at least one statistic. The set of functions also includes generating and outputting a user interface including the at least one statistic of each of the plurality of unique senders, receiving an input through the user interface, and, in response to the input, initiating at least one action for at least one of the plurality of unique senders. The at least one action includes at least one selected from a group consisting of deleting electronic communications received from at least one of the plurality of unique senders from the electronic communications account of the user and unsubscribing from communications transmitted by the at least one of the plurality of unique senders.

### BRIEF DESCRIPTION OF THE DRAWINGS

FIG. 1 schematically illustrates a system for tracking and controlling email messages according to one embodiment.

FIG. 2 schematically illustrates a server included in the system of FIG. 1 according to one embodiment.

FIG. 3 is a flowchart illustrating a method of tracking and controlling email messages performed by the system of FIG. 1 according to one embodiment.

FIG. 4 illustrates a graphical user interface displaying statistics about senders of email messages generated as part of the method of FIG. 3.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

As described above, a user's electronic mailbox often gets cluttered with mass communications, including solicited mass communications, and many users find themselves reporting or marking the mass communications as unwanted or undesired emails. The user must also manually locate and delete or move each received mass communication, which the user may perform without knowing what communications take the most space in their inbox or might contribute most to their sense of a cluttered mailbox.

Accordingly, the systems and methods described herein determine a plurality of mass communications received by a user (through an email account), determine a plurality of unique senders of the plurality of mass communications, determine one or more statistics for each of the plurality of unique senders, and generate and output a user interface including the at least one statistic for each of the unique senders. The user interface provides the user with insight into received mass communications and the impact particular senders have on the user's mailbox. The user interface also allows a user to delete, move, or unsubscribe from all mass communications received from one or more senders. Accordingly, the user interface provides insight into and allows a user to take action on mass communications as a group, which reduces errors, time, and computing resources.

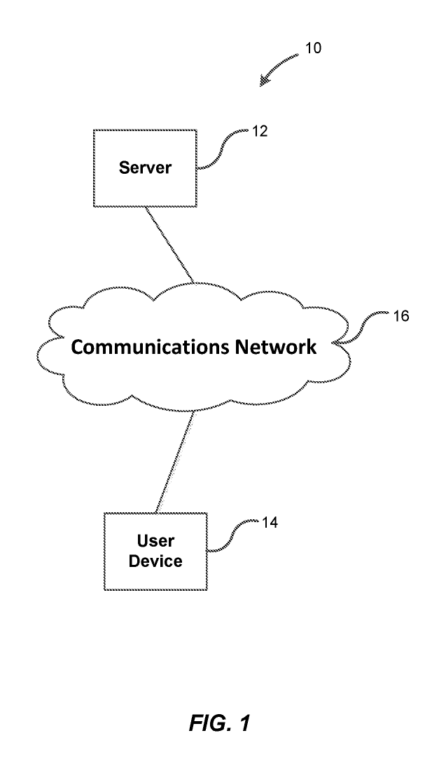

For example, FIG. 1 schematically illustrates a system 10 for tracking and controlling mass communications. As illustrated in FIG. 1, the system 10 includes a server 12 and a user device 14. It should be understood that the system 10 is provided as an example and, in some embodiments, the system 10 may include additional components. For example, the system 10 may include multiple servers 12, multiple user devices 14, or a combination thereof.

The server 12 and the user device 14 are communicatively coupled via a communications network 16. The communications network 16 may be implemented using a wide area network, such as the Internet, a local area network, such as a Bluetooth™ network or Wi-Fi, a Long Term Evolution (LTE) network, a Global System for Mobile Communications (or Groupe Spécial Mobile (GSM)) network, a Code Division Multiple Access (CDMA) network, an Evolution-Data Optimized (EV-DO) network, an Enhanced Data Rates for GSM Evolution (EDGE) network, a 3G network, a 4G network, and combinations or derivations thereof. In some embodiments, rather than or in addition to communicating over the communications network 16, the server 12 and user device 14 may communicate over one or more dedicated (wired or wireless) connections. In addition, in some embodiments, the server 12 and the user device 14 may communicate over one or more intermediary devices, such as routers, servers, gateways, relays, and the like.

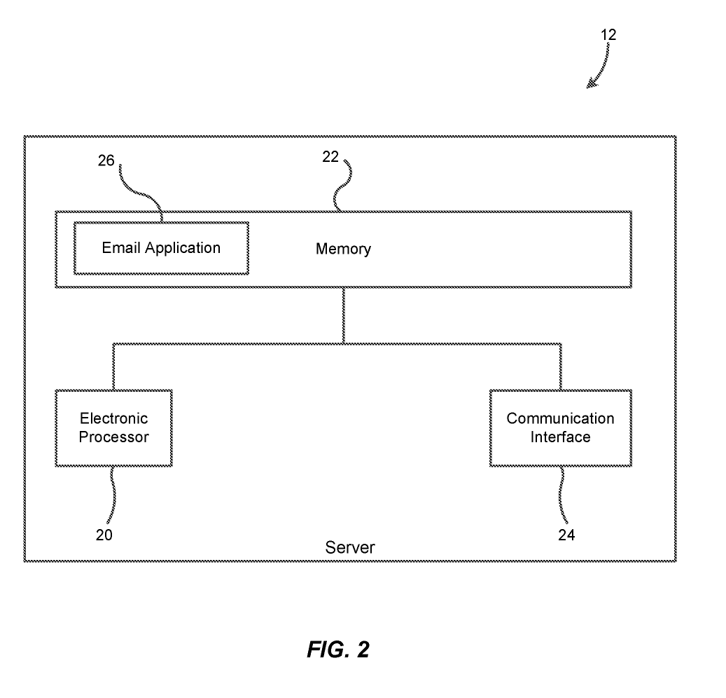

FIG. 2 schematically illustrates the server 12 in more detail. As illustrated in FIG. 2, the server 12 includes an electronic processor 20, a memory 22, and a communication interface 24. The electronic processor 20, the memory 22, and the communication interface 24 communicate over one or more communication lines or buses, wirelessly, or a combination thereof. In some embodiments, the server 12 includes additional components than those illustrated in FIG. 2 and the components included in the server 12 may arranged in various configurations. The server 12 may also perform additional functionality than the functionality described in the present application. Also, the functionality described herein as being performed by the server 12 may be distributed among multiple devices, such as multiple servers, and may be provided through a cloud service.

The electronic processor 20 may include a microprocessor, application-specific integrated circuit (ASIC), or another suitable electronic device. The electronic processor 20 is configured to retrieve data from the memory 22 and execute, among other things, software related to the processes and methods described herein. The memory 22 includes a non-transitory, computer-readable storage medium. The communication interface 24 may include a transceiver (for example, a Wi-Fi or Ethernet transceiver) for communicating over the communications network 16 and, optionally, one or more additional wired or wireless communication networks or connections.

The server 12 may include an email application 26 stored in the memory 22 in a format that is executable by the electronic processor 20. The email application 26 (when executed by the electronic processor 20) provides email messaging services for one or more user accounts, and may provide additional productivity services such as a calendar service, a contact service, a task management service, and the like. For example, in some embodiments, the email application 26 provides functionality similar to Outlook® provided by Microsoft Corporation. In some embodiments, the functionality described herein as being performed by the email application 26 is distributed between multiple applications executed through the server 12 or multiple servers 12. For example, in some embodiments, the functionality described herein relating to tracking and controlling mass communications may be provided through a separate mass communication application that interacts with (as a plug-in) the email application 26.

Returning to FIG. 1, the user device 14 is a personal computing device (for example, a desktop computer, a laptop computer, a terminal, a tablet computer, a smart telephone, a wearable device, or the like) that includes similar components as the server 12. In some embodiments, the user device 14 also includes one or more human machine interfaces, such as a display, a touchscreen, a keyboard, a keypad, a cursor-control device, and the like. In some embodiments, the user device 14 allows a user to access functionality provided by the server 12 via the communications network 16, including functionality provided by the email application 26. The user device 14 may access the functionality provided by the server 12 using a browser application, a dedicated software client, or the like.

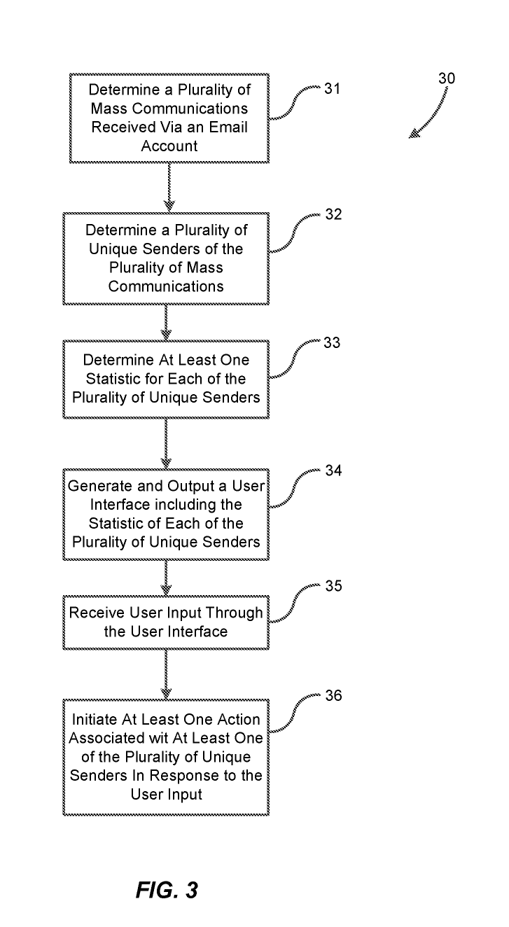

FIG. 3 illustrates a method 30 of tracking and controlling mass communications performed by the system 10. The method 30 is described herein as being performed by the electronic processor 20 of server 12 through execution of the email application 26. However, as noted above, in some embodiments, this functionality may be performed through execution of multiple applications executed by the server 12 or multiple servers.

As illustrated in FIG. 3, the method 30 includes determining, with the electronic processor 20, a plurality of mass communications received by a user (a user of the user device 14) via an email account of the user (at block 31). The electronic processor 20 may determine the plurality of mass communications by accessing data records representing email messages associated with a user account (stored in the memory 22, another memory included in the server 12, or a memory external to the server 12) and processing the email messages to determine what email messages are mass communications (as compared to peer-to-peer communications). As noted above, a mass communication may be a bulk electronic communication, such as an email, sent from a sender to each of a plurality of individuals. The senders of such mass communications include individuals, organizations, companies, schools, brands, and the like, and mass communications may be sent in a solicited or unsolicited manner.

In some embodiments, the electronic processor 20 determines whether an email message is mass communication by analyzing the metadata of an email message, such as an email header. An email header may include sender information, recipient information (such as what other individuals received the message), an email address to use for replies, date and time information (for sending, receiving, or both), the subject line, email server and service names and addresses (Internet Protocol (IP) addresses), results of spam or filtering tests, data for unsubscribing (a ListUnsubscribe field), data for accessing logos or images associated with the email message, or a combination thereof. For example, the electronic processor 20 may be configured to analyze the email address of the sender of an email message (or a reply email address) to determine if the email address has a format or terms common for mass communications, such as “noreply” or “mailbox.” Alternatively or in addition, the electronic processor 20 may determine whether an email header includes data for unsubscribing to the email.

Alternatively or in addition, the electronic processor 20 may be configured to determine of the plurality of mass communications by analyzing the content or body of received email message. For example, the electronic processor 20 may be configured to search for particular words, phrases, images, icons, and the like within the message content, such as the terms “unsubscribe,” “sale,” “newsletter,” and the like. Similarly, the electronic processor 20 may be configured to identify an unsubscribe link included in the message content.

In some embodiments, the electronic processor 20 may also be configured to allow a user to configure a list of known senders of mass communications (for example, by sender email address), which the electronic processor 20 may use to identify mass communications. Similarly, the electronic processor 20 may have access to shared lists of such senders, which may be configured and maintained by multiple sources, such as multiple users. In addition, in some embodiments, the electronic processor 20 may use a list of known senders who do not transmit mass communications, which the electronic processor 20 may use to eliminate some email messages that may other be identified as mass communications.

After determining the plurality of mass communications, the electronic processor 20 determines a plurality of unique senders for the plurality of mass communications (at block 32). The electronic processor 20 may determine the unique senders by identifying unique email addresses of senders (using information in email headers). Alternatively or in addition, the electronic processor 20 may determine unique senders by identifying unique corporate or other organization data (such as logos, trademarks, and the like) in an email header or the content of the email message. For example, the electronic processor 20 may be configured to consider mass communications received from different email addresses as being sent by one unique sender when the electronic processor 20 determines that the communications originated from the same source (included the same logos, company names, images, and the like).

For each unique sender, the electronic processor 20 determines at least one statistic about each unique sender based on the plurality of mass communications (at block 33). This statistic may generally be based on the mass communications associated with a sender. For example, the statistic may be a number mass communications received by the user via the email account from each of the plurality of unique senders, a frequency of mass communications transmitted by each of the plurality of unique senders to the user via the email account, a number of mass communications received and read by the user via the email account from each of the plurality of unique senders, a number of mass communications from each of the plurality of unique senders responded to (replied to, forwarded, saved, printed, deleted, moved, and the like), how recently a mass communication was received from each of the plurality of unique senders, a number of mass communications received by the user for each of the plurality of unique senders where the mass communications included attachments, a length of time the user has kept a mass communication from each unique sender in the email account, a percentage of the user's mailbox capacity represented by the received mass communications, and the like. The electronic processor 20 may determine one or more statistic for each unique sender, and, in some embodiments, the electronic processor 20 may determine different statistics for different unique senders.

The electronic processor 20 generates and outputs a user interface including the statistics for the unique senders (at block 34). In some embodiments, the user interface includes at least one statistic for each of the plurality of unique senders. In other embodiments, the electronic processor 20 may be configured to filter the statistics, the unique senders, or both included in the user interface. For example, the electronic processor 20 may be configured to filter out unique senders with a statistic that fails to satisfy a minimum number or threshold and not include such senders or their associated statistics in the user interface. In some embodiments, the electronic processor 20 outputs the user interface by transmitting the user interface to the user device 14, which displays the user interface on a human machine interface, such as a display or a touchscreen. As described herein, the user interface is generated by the email application 26. Accordingly, in this embodiment, a user may be able to access the user interface by selecting an option from a menu available through the email application 26 and the user interface may be displayed within a user interface displaying the user's mailbox or in a separate user interface or window. In fact, in some embodiments, the user interface may be provided as a dashboard within the email application 26 that allows a user to see (in real or near real time) statistics for mass communication. However, as noted above, in other embodiments, the user interface may be generated by a plug-in or separate application that interfaces with the email application 26 or the user's email account and, thus, may be displayed separate from user interfaces generated by the email application 26.

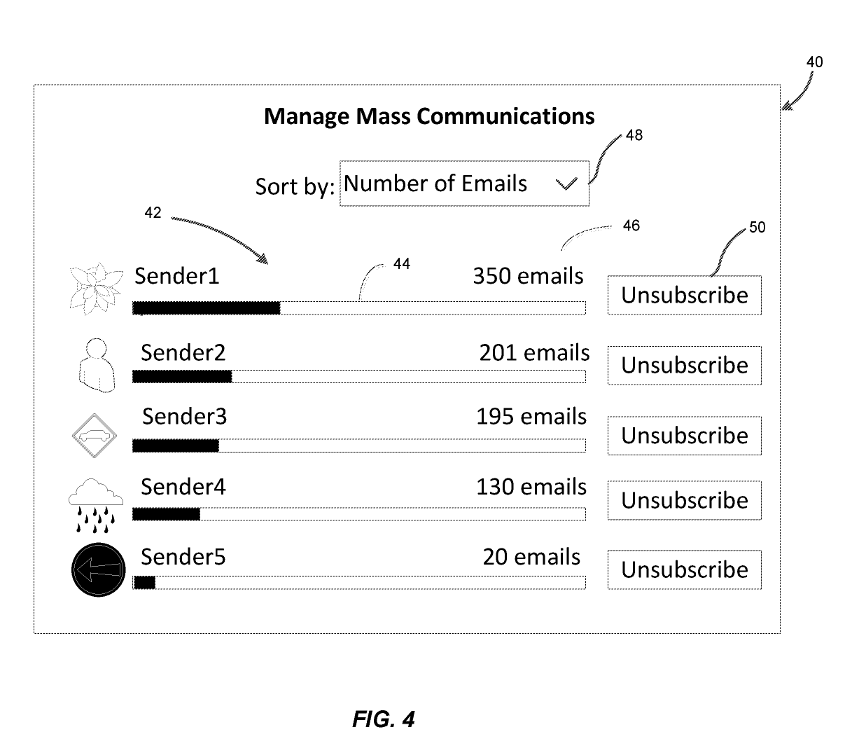

FIG. 4 illustrates one example of the user interface 40 generated by the electronic processor. As shown in FIG. 4, the user interface 40 lists a plurality of unique senders (Sender1, Sender2, Sender3, Sender4, and Sender5) and provides a statistic 42 for each sender (a number of mass communications received by the user from each sender). The statistic may be textual, graphical, or a combination thereof. For example, the statistics 42 illustrated in FIG. 4 each include a graphical bar 44 representing a number of communications and text 46 indicating an actual number of communications. As noted above, the user interface 40 may display more than one statistic per sender and may include other information for the senders, such as a sender logo or other company information.

In some embodiments, the user interface generated by the electronic processor 20 also includes one or more input mechanisms (virtual buttons, radio buttons, checkboxes, dialog windows, menus, voice prompts, and the like) for receiving user input. For example, in some embodiments, the user interface also includes one or more input mechanisms that allow a user to modify the information included in the user interface in response to the user input. For example, as illustrated in FIG. 4, the user interface 40 may include a sort drop-down menu 48 that, when selected by the user, sorts the list of unique senders by a particular statistic or property (alphabetically) in one or more orders (for example, highest to lowest or lowest to highest). The user interface may include similar input mechanisms for changing statistics included in the user interface 40, removing senders from the user interface 40, filtering senders (such as limiting senders listed in the user interface 40 to those senders transmitting more than twenty communications or displaying the sender associated with the most recent mass communication), and the like. In some embodiments, the user interface 40 may also include input mechanisms that allow a user to configure the format or structure the user interface 40 as well as adding or removing senders from any lists used by the electronic processor 20 to determine mass communications. For example, when the user interface 40 lists a sender that the user knows does not send mass communication (or the user otherwise does not want the sender included in the user interface), the user can not only remove the sender from the user interface 40 but also prevent the electronic processor 20 from including the sender in future renderings or refreshes of the user interface 40.

The user interface 40 may also include one or more input mechanisms that allow a user to initiate one or more actions relating to one or more senders listed in the user interface. For example, as illustrated in FIG. 4, the user interface 40 may include an unsubscribe button 50 associated with each listed sender. In response to a user selecting the unsubscribe button 50, the electronic processor 20 may unsubscribe the user from mass communications transmitted by the associated sender. In some embodiments, the user interface may include a similar input mechanism that allows a user to initiate other actions, such as deleting communications from a sender, moving previously-received communications from a sender to a predetermined storage location (for example, a folder within the user's email account), setting a rule to automatically move future communications received from a sender to a predetermined storage location, setting a rule to automatically delete or move a communication from a sender after a predetermined amount of time, setting a rule to automatically unsubscribe from communications from a sender after a predetermined amount of time or in response to other predetermined triggers, and the like. In some embodiments, the user interface also includes input mechanisms that allow a user to initiate an action for multiple senders (all listed senders, selected listed senders, listed senders satisfying predetermined thresholds, and the like).

For example, returning to FIG. 3, the electronic processor 20 receives input through the user interface (at block 35) and, in response to the input, initiates at least one action associated with at least one of the plurality of unique senders (at block 36). As noted above, the at least one action may include deleting previously-received mass communications received from a sender within the user's email account, unsubscribing the user from mass communications from a sender, moving mass communications from the sender to a predetermined storage location (such as a folder as indicated by the user, like a spam folder or junk mail folder), creating a rule for automatically moving or deleting future mass communications received from a sender, or a combination thereof. Alternatively or in addition, the at least one action may include creating an automatically generated response email for mass communications received from a sender, marking mass communications from a sender as “read” or “received,” categorizing mass communications from a sender for future sorting or filtering, and the like. In some embodiments, the electronic processor 20 may initiate one or more of the above actions for all mass communications associated with a sender. However, in other embodiments, the electronic processor 20 may initiate an action for only some mass communications. For example, when deleting mass communications, the electronic processor 20 may be configured to delete all stored mass communications received from a sender or only those communications that satisfy one or more conditions, such as those communications received more than thirty days ago, those communications marked as “read,” or the like. The electronic processor 20 may be configured to apply default conditions or custom conditions set by (or selected through the user interface by) the user. In some embodiments, after performing one or more actions, the electronic processor 20 may be configured to refresh the user interface. For example, when a user deletes stored communications from a particular sender, the electronic processor 20 may be configured to refresh the user interface to remove that sender.

When a user initiates an unsubscribe action for one or more senders, the electronic processor 20 may be configured to unsubscribe the user in one or more ways. For example, in some situations, the electronic processor 20 may submit data or a message directly to the sender on behalf of the user. In particular, the electronic processor 20 may use information in the email header or an unsubscribe link associated with a mass communication to submit data or a message to the sender. In this situation, the user is not required leave the email application 26 and the subscription occurs seamlessly from the user's perspective. In other situations, the electronic processor 20 may be configured to unsubscribe the user by opening a webpage (through a browser application) where a user can submit a request to unsubscribe. For example, the electronic processor 20 may use an unsubscribe link included in an email message to automatically open the unsubscribe webpage of the sender where the user can confirm his or her decision to unsubscribe and enter any other data needed to complete the unsubscribe process. In some embodiments, in either situation, the electronic processor 20 is configured to confirm unsubscribing with the user before initiating any action. The electronic processor 20 may also store data regarding mass communications the user unsubscribed to. The electronic processor 20 may use the stored data to automatically establish rules for received emails (automatically delete any future communications from the sender that may be received before the unsubscribe process is complete), update lists of known senders of mass communications, and the like.

Also, in some embodiments, the electronic processor 20 may be configured to automatically taken one or more actions based on generated statistics. For example, in response to a particular sender sending emails at a frequency that exceeds a predetermined maximum threshold (which may be set or configured to a user), the electronic processor 20 may automatically unsubscribe the user from mass communications transmitted by the sender. The electronic processor 20 may be configured to consider multiple statistics or conditions before taking one or more automatic actions. For example, the electronic processor 20 may determine email frequency, date of last email, date of last email read by the user, or a combination thereof.

The functionality described above may be performed for a single email account or multiple email accounts associated with one user or a group of users. For example, a company may want to use the above functionality to determine what sources of mass communications are impacting the mailboxes of their employees and create intelligent policies to manage mass communications. In addition, the functionality described above is not limited to email messages but can be applied to any type of electronic communication, including instant messaging communications, text communications, social media communications, and the like.

Similarly, the functionality described above is not limited to mass communications but can be used to provide sender-level statistics and actions for communications having a predetermined property or all received communications. For example, a user may use the above user interface to identify what senders (including peers) send the most communications or the most frequent communications and take appropriate actions. For example, through a user interface as described above, a user may determine that a particular peer routinely sends communications that that user never reads or always deletes. Thus, the user may, through the user interface, set up a rule for communications from this peer to keep the user's mailbox from being cluttered and unmanageable. Similarly, a user may use the above user interface to identify what senders send communications on particular subjects, with attachments, at particular dates or times, and the like, and take appropriate actions. As used in the present application, a property of a communication may include any information included in the email header, the content of the communication, or other metadata that allows the communication to be categorized or grouped with other similar communications.

Also, the functionality is described above as being performed by a server, such as an email server executing an email application 26. However, all or a portion of this functionality may be performed by a software application locally stored and executed by the user device 14. For example, the email application 26 may be stored on and executed by the user device 14. In other embodiments, the user device 14 may store and execute a software application that processes email messages as described above by interfacing with the email application 26. Similarly, the user device 14 may store and execute a software application that generates the user interface as described above based on data (statistics and sender listings) received from the email application 26.

Thus, embodiments described herein provide methods and systems for tracking and controlling mass communications, such as electronic newsletters. By generating and providing statistics on a sender level, a user can more intelligently decide what mass communications are worthwhile and what mass communications only clutter the user's mailbox. Furthermore, by allowing a user to delete, move, or subscribe one or multiple subscriptions, a user can quickly address the ever-growing number of email messages in their mailbox without manually addressing each individual message. These methods and systems are also applicable to any type of electronic communication and are not limited to tracking mass communications. Thus, the methods and systems provide novel technology for addressing the large amount of electronic communications exchanged in today's digital world.

Various features and advantages of some embodiments are set forth in the following claims.

What is claimed is:

1. A system for tracking and controlling mass communications, the system comprising:
an electronic processor configured to
determine a plurality of mass communications received by a user via an electronic communications account,
determine a plurality of unique senders of the plurality of mass communications,
determine, for each of the plurality of unique senders, at least one statistic,
generate and output a user interface including the at least one statistic of each of the plurality of unique senders,
receive an input through the user interface, and
in response to the input, initiate at least one action associated with at least one of the plurality of unique senders.

2. The system of claim 1, wherein the electronic communications account is an email account.

3. The system of claim 1, wherein the at least one statistic is a number of mass communications received by the user via the electronic communications account from each of the plurality of unique senders.

4. The system of claim 1, wherein the at least one statistic is a frequency of mass communications received by the user via the electronic communications account from each of the plurality of unique senders.

5. The system of claim 1 wherein the at least one statistic is a number of mass communications received and read by the user via the electronic communications account from each of the plurality of unique senders.

6. The system of claim 1, wherein the at least one action is at least one selected from a group consisting of deleting mass communications received from the at least one of the plurality of unique senders from the electronic communications account of the user, unsubscribing from mass communications transmitted by the at least one of the plurality of unique senders, and moving mass communications received from the at least one of the plurality of unique senders to a predetermined storage location.

7. The system of claim 6, wherein the predetermined storage location is a folder within the electronic communications account.

8. The system of claim 1, wherein the electronic processor is configured to determine the plurality of mass communications received by the user via the electronic communications account by identifying an unsubscribe link within a communication received by the user via the electronic communications account.

9. A method of tracking and controlling mass communications, the method comprising:
determining, with an electronic processor, a plurality of mass communications received by a user via an email account by identifying an unsubscribe link within a communication;
determining, with the electronic processor, a plurality of unique senders of the plurality of mass communications,
determining, with the electronic processor, for each of the plurality of unique senders, at least one statistic,
generating and outputting, with the electronic processor, a user interface including the at least one statistic of each of the plurality of unique senders,
receiving, with the electronic processor, an input through the user interface, and
in response to the input, initiating, with the electronic processor, at least one action for at least one of the plurality of unique senders.

10. The method of claim 9, wherein determining the at least one statistic including determining at least one selected from a group consisting of a number of mass communications received by the user via the email account from each of the plurality of unique senders, a frequency of mass communications received by the user via the email account from each of the plurality of unique senders, and a number of mass communications received and read by the user via the email account from each of the plurality of unique senders.

11. The method of claim 9, wherein initiating the at least one action includes deleting mass communications received from the at least one of the plurality of unique senders from the email account of the user.

12. The method of claim 9, wherein initiating the at least one action includes unsubscribing from mass communications transmitted by the at least one of the plurality of unique senders.

13. The method of claim 9, wherein initiating the at least one action includes moving mass communications received from the at least one of the plurality of unique senders to a predetermined storage location.

14. A non-transitory computer-readable medium including instructions executable by an electronic processor to perform a set of functions, the set of functions comprising:
determining a plurality of electronic communications having a predetermined property received by a user via an electronic communications account;
determining a plurality of unique senders of the plurality of electronic communications;
determining, for each of the plurality of unique senders, at least one statistic;
generating and outputting a user interface including the at least one statistic of each of the plurality of unique senders;
receiving an input through the user interface, and
in response to the input, initiating at least one action for at least one of the plurality of unique senders,
wherein the at least one action includes at least one selected from a group consisting of deleting electronic communications received from at least one of the plurality of unique senders from the electronic communications account of the user and unsubscribing from communications transmitted by the at least one of the plurality of unique senders.

15. The non-transitory computer-readable medium of claim 14, wherein the at least one statistic is at least one selected from a group consisting of a number of electronic communications received by the user via the electronic communications account from each of the plurality of unique senders, a frequency of electronic communications received by the user via the electronic communications account from each of the plurality of unique senders, and a number of mass communications received and read by the user via the electronic communications account from each of the plurality of unique senders.

16. The non-transitory computer-readable medium of claim 14, wherein determining the plurality of electronic communications having the predetermined property received by the user via the electronic communications account includes identifying predetermined content included in a body of an electronic communication received by the user via the electronic communications account.

17. The non-transitory computer-readable medium of claim 14, wherein determining the plurality of electronic communications having the predetermined property received by the user via the electronic communications account includes identifying predetermined information included in a header of an electronic communication received by the user via the electronic communications account.

18. The non-transitory computer-readable medium of claim 14, wherein initiating the at least one action includes initiating the at least one action for at least two of the plurality of unique senders.

19. The non-transitory computer-readable medium of claim 14, wherein the set of functions further comprises
receiving a second input through the user interface, and
filtering statistics included in the user interface based on the second input.

20. The non-transitory computer-readable medium of claim 14, wherein the set of functions further comprises
receiving a second input through the user interface, and
sorting statistics included in the user interface based on the second input.
